(19) United States
(12) Patent Application Publication
(10) Pub. No.: US 2004/0227016 A1
(43) Pub. Date: Nov. 18, 2004

(54) Nozzle and method of jetting fluid into inner peripheral surface of conduct by the nozzle

(76) Inventors: Shuichi Yagi, Tokyo (JP); Takashi Shigefuji, Tokyo (JP); Seita Shimizu, Tokyo (JP); Toshiaki Mizumoto, Hiroshima (JP); Akio Shimizu, Hiroshima (JP); Shigeyuki Mine, Hiroshima (JP)

Correspondence Address: BIRCH STEWART KOLASCH & BIRCH, PO BOX 747, FALLS CHURCH, VA, 22040-0747, US

(21) Appl. No.: 10/487,985

(22) PCT Filed: Aug. 26, 2002
(86) PCT No.: PCT/JP02/08584

(30) Foreign Application Priority Data
Aug. 28, 2001 (JP) 2001-2558807
Aug. 21, 2002 (JP) 2002-240920

(51) Int. Cl. B05B 1/34

(52) U.S. Cl. 239/524; 239/518; 239/463; 239/469; 239/486

(57) ABSTRACT

A nozzle, comprising a nozzle body (11), a nozzle tip (12) stored in the nozzle body and a deflector (15) fitted to the tip side of the nozzle, the nozzle tip (12) further comprising a swirl groove (12g) in the rear end face (12d) thereof and a jetting nozzle (12k) projectedly provided thereon with the inner diameter thereof increased at the tip side, the deflector (15) further comprising a support bar (15a) and an impact plate part (15b) connected to each other through a continuous portion (15d) formed of a curved surface and smoothly continued to an impact surface (15c), wherein swirl fluid (T) is jetted from the jetting nozzle (12k) and deflected at the continuous portion (15d) to outwardly jet the fluid widely along the impact surface (15c).

### TECHNICAL FIELD

The present invention relates to a nozzle and method of jetting a fluid to an inner peripheral surface of a conduit by means of the nozzle. More particularly, the present invention relates to a nozzle that jets a fluid to the periphery thereof in a wide range. In particular, the nozzle is so constructed to realize wide-angle and uniform jetting without dripping of the fluid, even though the fluid has a high viscosity. The nozzle is used suitably to apply paint to the inner peripheral surface of the conduit.

### BACKGROUND ART

Heretofore, as a nozzle capable of jetting a fluid at an angle larger than 90 degrees with respect to the axis of the nozzle, there are proposed a large number of nozzles each having an umbrella-shaped deflector mounted thereon.

In the nozzles provided with the deflector, a fluid jetted from a jetting nozzle is impacted against an impact plate portion of the deflector confronting the jetting nozzle and is then jetted to the periphery of the jetting nozzle along the impact plate portion.

FIG. 17(A) shows the powder spray apparatus 1 disclosed in Japanese Patent Application Laid-Open No. 9-503957. The powder spray apparatus 1 has the nozzle 2 having the deflector. The nozzle 2 has the conic first deflector 2b provided on the conduit 2a for a fluid and the second deflector 2d provided at the nozzle tip 2c. The flow direction of the fluid flowing in the conduit 2a is deflected outward by the first deflector 2a, deflected widely by the second deflector 2d, and jetted to the periphery of the nozzle 2.

The spray apparatus 3 disclosed in Japanese Patent Application Laid-Open No. 62-97654 has the umbrella-shaped deflector 3b at the tip of the nozzle portion 3a. In Japanese Patent Application Laid-Open No. 10-244016, the nozzle 4 having the deflector 4a is disclosed. In addition, as shown in FIG. 18(C), the nozzle 5 in which the flow path 5c is formed on the periphery of the support bar 5b of the deflector 5a is known.

Because the above-described nozzles having the deflector respectively are capable of jetting a fluid at a wide angle by the deflector, as shown in FIG. 17(B), they are frequently used to jet the fluid into a hollow body such as a drum 6.

In the above-described conventional nozzles having the deflector respectively, the fluid flowing inside the nozzle is impacted against the impact plate portion of the deflector without the flow of the fluid being made turbulent. Thus it is difficult to fine-grain the fluid to be jetted. Therefore the thickness of the jetted fluid film is not uniform, and it is difficult to make a jetting pattern stable. When a jetting angle is set widely, the above phenomenon is frequently outstanding, and nonuniform jetting is liable to occur. Further owing to splash of the fluid which has impacted the deflector, the fluid attaches to the periphery of the jetting nozzle and dripping occurs, which prevents jetting of the fluid from the jetting nozzle.

To overcome the difficulty in fine-graining the fluid to be jetted, in a nozzle 5 shown in FIG. 18(C), the inner diameter of the flow path 5c is set small to raise a fluid pressure. The nozzle having this construction is liable to clog owing to the presence of a foreign matter contained in the fluid flowing in the flow path 5c. Thus much labor is required for maintenance. Further when the fluid to be jetted is viscous, it is impossible to make the jetting angle of the fluid large because a pressure loss is great in the small-diameter flow path 5c of the nozzle 5. More specifically, in the nozzle 8 shown in FIG. 19(A), the jetting angle can be set to about 80 degrees when a jetting pressure is about 10 Mpa and when the fluid is water. But in the case of a fluid having a high viscosity of 100 CP, the jetted fluid drips from the nozzle, as shown in FIG. 19(B). Thus a jetting pattern cannot be secured.

The present invention has been made in view of the above-described problems. Therefore it is a first object of the present invention to provide a nozzle, having a deflector, capable of fine-graining a fluid and jetting it at a wide angle by properly sizing a necessary portion of the nozzle to allow passage of a foreign matter. It is a second object of the present invention to provide a nozzle capable of jetting a fluid at a wide angle, even if the deflector is not used.

It is a further object of the present invention to provide a nozzle that is capable of jetting a fluid uniformly at a wide angle, even if a fluid to be jetted has a high viscosity and can be used suitably when paint is jetted to the inner peripheral surface of a conduit.

### DISCLOSURE OF THE INVENTION

The first invention provides a nozzle in which a swirl chamber communicating with a jetting nozzle disposed at a center of a jetting-side front-end wall is provided; a support bar of a deflector is penetrated through the jetting nozzle with a gap formed between the support bar and a periphery of the jetting nozzle and is projected inward; an impact plate portion of the deflector is provided at an end portion of the support bar outward projected; and the impact plate portion is disposed in confrontation with the jetting-side front-end wall,

a fluid jetted in a swirl state from the swirl chamber through the jetting nozzle is impacted against the impact plate portion of the deflector to jet the fluid peripherally outwardly from a gap between the impact plate portion and the jetting-side front-end wall.

As described above, when the nozzle is provided with the swirl chamber, the fluid in a swirl state impacts the impact plate portion of the deflector. Thus the fluid jetted outward on the periphery of the nozzle by deflecting the fluid by the deflector can be fine-grained, and the thickness of the film of the jetted fluid can be made uniform. Further by swirling the flow of the fluid jetted from the jetting nozzle, it is possible to make the amount of the fluid jetted to the periphery of the jetting nozzle uniform and easy to flow the fluid in conformity to the angle of the impact surface of the impact plate portion of the deflector. Thus the jetting pattern and the jetting angle can be easily adjusted in conformity to the configuration of the impact plate portion of the deflector. Thereby it is possible to set the jetting angle to a wide angle and a wide range.

By using the deflector having the above construction, even if the fluid to be jetted has a high viscosity, it is possible to secure wide and uniform spray owing to the swirl flow of the fluid generated in the swirl chamber. Further because a gap is formed between the support bar of the deflector and the periphery of the jetting nozzle, this portion secures a sufficient dimension large enough for a foreign matter to pass therethrough. Thus it is possible to prevent clogging of the foreign matter.

The jetting nozzle is formed on a nozzle tip accommodated inside a nozzle body at a jetting side thereof; a cavity portion is formed inside the nozzle tip at a fluid inflow side thereof; and an adapter is fitted on an end portion of the nozzle tip at the fluid inflow side thereof in such a way as to close the cavity portion to thereby function the cavity portion as the swirl chamber;

a swirl flow path is formed on a peripheral portion of the nozzle tip to flow a fluid flowing along a flow path formed between an inner surface of a peripheral wall of the nozzle body and a periphery of the nozzle tip as well as the adapter into the swirl chamber as a swirl flow through the swirl flow path; and

an end portion, of the support bar of the deflector, disposed opposite to the impact plate portion is removably mounted on a front-end surface of the adapter.

By fixing the nozzle tip having the cavity portion and the swirl flow path by means of the adapter inside the nozzle body, it is possible to swirl the fluid sufficiently and secure a sufficient dimension for the swirl flow path. Thus it is possible to prevent clogging of the foreign matter. Because the nozzle of the present invention ensures a large dimension for foreign matter passage portion, the nozzle is suitable for spraying a small amount of a fluid.

As the swirl flow path, it is possible to form the curved swirl groove communicating with the cavity portion on the fitting surface of the peripheral wall of the nozzle tip or form the curved swirl opening communicating with the peripheral wall portion of the nozzle tip and the cavity portion. The fluid may be swirled by using a whirler. The nozzle is composed of a plurality of component parts such as the nozzle body, the nozzle tip, and the adapter, and the flow path is formed in the nozzle. Thus the construction inside the nozzle may be complicated. But by processing each component part, it is possible to prevent an increase of the cost.

Because the support bar of the deflector is penetrated through the jetting nozzle and is projected inside the nozzle body, the support bar is positioned at the center of the cavity portion (swirl chamber) and serves as the axis or the nucleus of the swirl flow. Thus the fluid can be forcibly swirled around the support bar. Further the support bar of the deflector passes through the cavity portion of the nozzle tip and is removably fixed to the adapter. Therefore deflectors having various configuration can be exchanged with each other. Thus according to purpose of fluid jetting, the jetting angle can be changed, and the jetting amount can be varied in dependence on jetting directions. Because the adapter fixing the support bar of the deflector is fitted on the nozzle tip, positioning of the adapter and nozzle tip can be accomplished accurately. Consequently the support bar of the deflector can be accurately positioned at the center of the jetting nozzle of the nozzle tip.

A front-end surface of the nozzle tip at which the jetting nozzle is formed is fitted on an aperture formed at a front-end portion of the nozzle body; and a peripheral portion of the jetting nozzle of the nozzle tip is projected from the front-end surface of the nozzle tip; and an inner diameter of the jetting nozzle is enlarged gradually toward a front end thereof. Because the peripheral portion of the jetting nozzle of the nozzle tip is projected from the front-end surface of the nozzle tip, fluid can be eliminated from the periphery of the jetting nozzle, and thus very little fluid attaches thereto. Further the inner diameter of the jetting nozzle is enlarged gradually toward the front end thereof. Thus a large diameter can be secured to allow a foreign matter to pass through the jetting nozzle without clogging. Since the inner diameter of the jetting nozzle is enlarged gradually toward the front end thereof, the flow direction of the jetted fluid is widened outward. Thus enlargement of the inner diameter of the jetting nozzle contributes to stabilization of a spray pattern when the jetting angle is set to a wide angle.

A continuous portion continuous with a support bar of the deflector and an impact plate portion thereof is tapered and formed as a curved surface in conformity to an angle of the jetting nozzle. When the continuous portion continuous with the support bar and the impact plate portion is formed in this configuration, by combining the continuous portion with the diameter-enlarged portion of the jetting nozzle, it is possible to flow the fluid smoothly along the tapered curved surface. Further it is possible to prevent the fluid from strongly impacting the continuous portion continuous with support bar and the impact plate portion and thus prevent the jetting direction of the fluid from becoming nonuniform and scattering to the periphery of the jetting nozzle. Thereby the impact of the fluid is gentle, and a reliable spray pattern can be secured. Even when the jetting angle is wide, it is possible to prevent the spray pattern from being destroyed.

An impact surface, of the impact plate portion of the deflector, disposed at a side of the jetting nozzle is formed at an angle of not less than 25 nor more than 90 degrees to the support bar. By forming the impact surface of the deflector at various angles, the nozzle can be used for various uses. For example, when the fluid is desired to be jetted vertically to a surface to which the fluid is jetted, a deflector whose impact surface is at right angles to its support bar should be used. Further by inclining the impact surface at an angle in the above-described range, it is possible to prevent scattering of an atomized fluid, prevent a spray from attaching to the support bar and the like, and secure a stable atomized state in successive fluid jetting. Because the deflector is removably fixed to the adapter, the deflector can be exchanged suitably in dependence on purpose.

A distance between the impact plate portion of the deflector and the jetting-side front-end wall can be increasingly or decreasingly changed. When the distance between the impact plate portion and the jetting-side front-end wall is adjustable, the fluid impacts the impact plate portion in different states. Thus various atomizing modes are applicable in dependence on purpose. More specifically, when the distance between the impact plate portion and the jetting-side front-end wall is set long, the fluid impacts the impact plate portion in a state in which the fluid spreads along the configuration of the jetting nozzle. Thus the thickness of the fluid film at the impact surface of the impact plate portion is large, and the jetting speed from the impact plate portion is low. Consequently the particle diameter of the fluid is large.

On the other hand, when the distance between the impact plate portion and the jetting-side front-end wall is set short, the fluid impacts the impact plate portion in a state in which the fluid does not spread much from the jetting nozzle. Thus the thickness of the fluid film at the impact surface is small, and the loss of the jetting speed is small. Consequently the particle diameter of the fluid is small. It is preferable to adjust the distance between the impact plate portion and the jetting-side front-end wall by mounting the support bar of the deflector on the nozzle tip from a shallow state to a deep state or exchanging one deflector whose support bar is long with the other deflector whose support bar is short or vice versa.

It is preferable that an outer diameter of the impact plate portion of the deflector is set smaller than an outer diameter of the jetting-side front-end wall. When the peripheral dimension of the impact plate portion is set smaller than the outer diameter of the nozzle body disposed at the jetting side, in the peripheral portion of the front-end wall, the impact plate portion is not present in confrontation with the front-end wall. Therefore when the fluid is jetted outward from the gap between the impact plate portion and the front-end wall at its jetting side, the fluid flows outward smoothly from the impact plate portion. Consequently it is possible to securely prevent an atomized fluid from attaching to the periphery of the front-end wall and the like and hence secure a stable spray state.

A periphery of the impact plate portion of the deflector is formed circularly or polygonally. When the impact plate portion having the above-described configuration is used, it is possible to accomplish a uniform spray and a nonuniform spray. For example, when the fluid is desired to be sprayed uniformly, the peripheral configuration of the impact plate portion should be circular. When the fluid is is desired to be sprayed nonuniformly to a specific direction, the impact plate portion should be formed in a configuration having a corner according to a jetting direction. As configurations other than the above-described configurations, the impact plate portion may be formed elliptically or asymmetrically.

When the impact surface of the deflector is set to various angles or the periphery of the impact plate portion is formed in various configurations, the fluid film is stable and the diameter of fine-grained particle changes very little because the fluid which impacts the deflector is in a swirl state. Therefore the nozzle of the present invention is suitable for jetting the fluid into the inside of a hollow body.

The second invention provides a nozzle capable of jetting a fluid at a wide angle, although the deflector is not mounted on the nozzle.

In the nozzle, a ring-shaped flow path is formed along an inner surface of a peripheral wall of a nozzle body; a swirl chamber communicating with a jetting nozzle positioned at a center of an end of the nozzle body at a jetting side thereof is formed; the swirl chamber and the flow path are communicated with each other through a pair of curved swirl flow paths formed at opposed positions; a trapezoidal conic protruded portion is formed at a center of the swirl chamber at an inflow side thereof; and a fluid flowing swirlingly into the swirl chamber is further swirled along a peripheral surface of the trapezoidal conic protruded portion and jetted from the jetting nozzle formed at a front end of the swirl chamber at a wide angle with the fluid being swirled.

As a result of experiments made by the present inventors, they have found that the fluid can be jetted at an angle wider than 90 degrees with respect to the axis of the deflector-unprovided nozzle by flowing the fluid into the swirl chamber with the fluid swirling, accelerating the swirling of the fluid inside the swirl chamber, and jetting the fluid from the jetting nozzle by swirling it.

Owing to this finding, the second invention provides the nozzle not provided with the deflector having the construction described above.

That is, because the trapezoidal conic protruded portion is present at the center of the swirl chamber, the fluid which has flowed into the swirl chamber with the fluid being swirled is forcibly swirled along the peripheral surface of the trapezoidal conic protruded portion. The flow of the fluid is accelerated in its spiral swirling with a centrifugal force applied to the fluid. Thus the fluid is jetted from the jetting nozzle at a wide angle with the fluid swirling. Further the swirling accelerates fine-graining of the fluid.

As described above, without mounting the deflector on the nozzle tip with the deflector disposed outward from the jetting nozzle of the nozzle and forcibly impacting the fluid against the impact plate portion to thereby convert the jetting direction to the direction outward from the direction along the periphery of the support bar, the fluid can be jetted from the jetting nozzle at an angle wider than 90 degrees to the axis of the nozzle in the direction outward from the direction along the periphery of the support bar.

It is preferable that an axis of the trapezoidal conic protruded portion is coincident with an axis of the jetting nozzle; a front-end surface of the trapezoidal conic protruded portion is disposed at a position proximate and opposed to the jetting nozzle; and a size of the jetting nozzle is set equally to a size of the front-end surface of the protruded portion.

When the protruded portion is projected to the position proximate to the trapezoidal conic protruded portion, the fluid is forcibly swirled along the periphery of the trapezoidal conic protruded portion until the fluid is jetted from the jetting nozzle. Therefore the fluid can be jetted from the jetting nozzle reliably in a swirl flow.

When the area of the front-end surface of the trapezoidal conic protruded portion is set almost equally to that of the jetting nozzle, the swirl flow of the fluid can be jetted in a large diameter from the jetting nozzle. Thus it is possible to increase the jetting distance in the peripheral direction.

It is preferable that an opening is concavely formed at a center, of the front-end surface of the protruded portion, positioned on an axis of an air core of a swirl flow swirled in the swirl chamber and jetted from the jetting nozzle; and the air core of the swirl flow is stably held at the center of the jetting nozzle. It is preferable that the opening concavely formed at the center of the front-end surface of the protruded portion is conically shaped to decrease the diameter of the opening toward the inner end thereof. But the opening may be a circular opening having an equal diameter.

By stably holding the air core of the swirl flow separating from the trapezoidal conic peripheral surface and swirlingly flowing to the jetting nozzle, it is possible to make the jetting distance from the jetting nozzle to the peripheral direction uniform and prevent drips from being generated by a part of the fluid disposed at the center of the swirl flow.

More specifically, similarly to the nozzle of the first invention, a nozzle tip is accommodated inside the nozzle body at a jetting side thereof; an adapter is accommodated inside the nozzle body at an inflow side thereof respect to the nozzle tip; the ring-shaped flow path is formed between a peripheral surface of the adapter and an inner peripheral surface of the nozzle body; and the trapezoidal conic protruded portion is projected from a front-end surface of the adapter at a jetting side thereof;

a jetting nozzle is formed at a front end of the nozzle tip; a cavity portion, having a large area, continuous with the jetting nozzle is formed inside the nozzle tip; the swirl chamber is formed by closing a fluid inflow side of the cavity portion with a front-end surface of the adapter; and a swirl groove is formed at a position, of an inner surface of a peripheral wall of the nozzle tip, opposed to the front-end surface of the adapter.

A fluid to be supplied to the nozzle is paint having a high viscosity of approximately 100 cp. The nozzle can be most suitably used to line a conduit such as a gas pipe by spraying two-part hardening resinous paint onto an inner peripheral surface of the conduit.

The third invention provides a method of jetting a fluid to an inner peripheral surface of a conduit by using the deflector-provided nozzle of the first invention or the deflector-unprovided nozzle of the second invention.

In the method of the third invention jetting a fluid to an inner peripheral surface of a conduit by means of a nozzle, the nozzle is moved inside the conduit at a required speed and a fluid is jetted to an inner peripheral surface of the conduit from the nozzle at an angle not less than 90 degrees with respect to an axis of the nozzle.

More specifically, a towing means such as a rope is mounted on a jetting apparatus on which the nozzle is mounted to allow a hollow part of the conduit to move axially. A guide roller mounted on the tip of an arm projected from the jetting apparatus is in contact with the inner peripheral surface of the conduit. The fluid is jetted from the nozzle at a wide angle while the jetting apparatus is moving.

According to the above-described method, the fluid can be almost uniformly jetted in all directions on the periphery of the nozzle. Thus by jetting the fluid from the nozzle with the nozzle being moved, the fluid can be jetted entirely to the inner peripheral surface of the conduit.

A fluid to be jetted from the nozzle consists of paint consisting of a two-part hardening resin having a high viscosity. The nozzle is capable of continuously forming a coating film having a uniform thickness by jetting the paint to the inner peripheral surface of the conduit.

### BRIEF DESCRIPTION OF THE DRAWINGS

FIG. 1 shows a nozzle according to a first embodiment of the present invention, in which FIG. 1(A) is a perspective view and FIG. 1(B) is a side view.

FIG. 2 is a sectional view showing main parts of the nozzle of the first embodiment.

FIG. 3 is an exploded perspective view of the nozzle of the first embodiment.

FIG. 4 shows a nozzle tip, in which FIG. 4(A) shows a rear-end surface of the nozzle tip, FIG. 4(B) is a sectional view taken along a line A-A of FIG. 4A, and FIG. 4(C) is a sectional view taken along a line B-B of FIG. 4 (A).

FIG. 5 is a side view of a deflector.

FIG. 6 is a sectional view of main parts of the nozzle, showing a jetting state of a fluid.

FIGS. 7(A), (B), and (C) are side views of a deflector of a modification.

FIG. 8 is a deflector of another modification, in which FIG. 8(A) is a front view; and FIG. 8(B) is a side view.

FIG. 9 is a sectional view showing main parts of a nozzle of a second embodiment.

FIG. 10 shows a jetting state of the nozzle of the second embodiment, in which FIG. 10(A) is a schematic view showing a state in which the interval between a deflector and a nozzle body is set long; and FIG. 10(B) is a schematic view showing a state in which the interval between the deflector and the nozzle body is set short.

FIG. 11 is a sectional view showing main parts of a nozzle of a third embodiment.

FIG. 12 is a schematic view showing a jetting state of the nozzle of the third embodiment.

FIG. 13 is a sectional view showing main parts of a nozzle of a fourth embodiment.

FIG. 14 is a schematic view showing a jetting state of the nozzle of the fourth embodiment.

FIG. 15 is a sectional view of main parts of a modification of the nozzle of the fourth embodiment.

FIGS. 16(A) and (B) show a fifth embodiment and are schematic views showing a method of painting an inner peripheral surface of a conduit by means of a nozzle.

FIG. 17 shows a conventional nozzle provided with a deflector, in which FIG. 17(A) is a partly sectional view; and FIG. 17(B) is a schematic view showing a use situation.

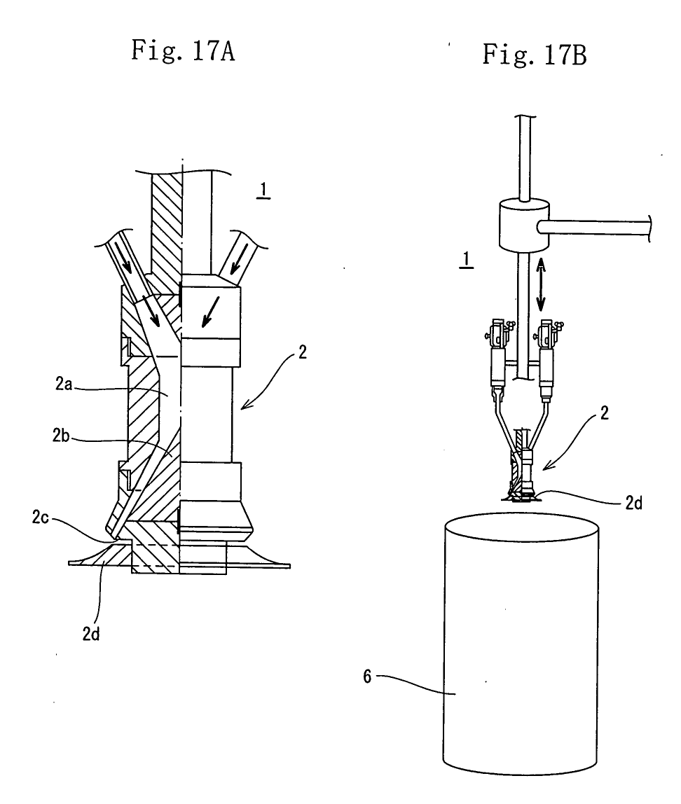

FIGS. 18(A), (B), and (C) are schematic views of conventional nozzles provided with a deflector respectively.

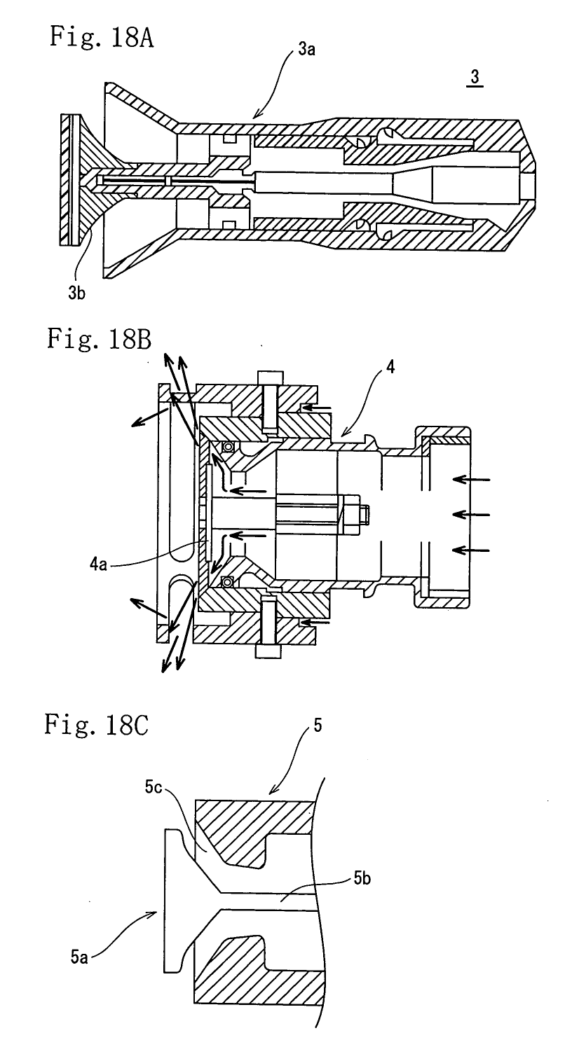

FIG. 19 shows a jetting situation of a fluid, in which FIG. 19(A) is a schematic view when the fluid is water; and FIG. 19(B) is a schematic view when the fluid has a high viscosity.

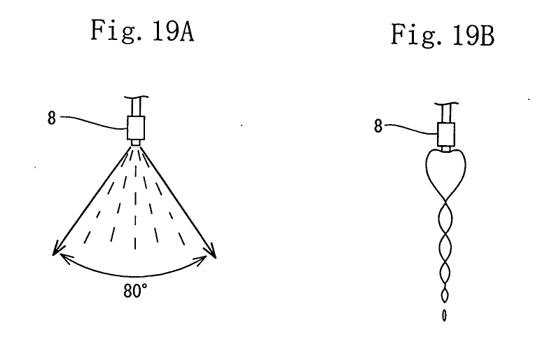

### BEST MODE FOR CARRYING OUT THE INVENTION

(First Embodiment)

A nozzle according to an embodiment of the present invention is described below with reference to the drawings.

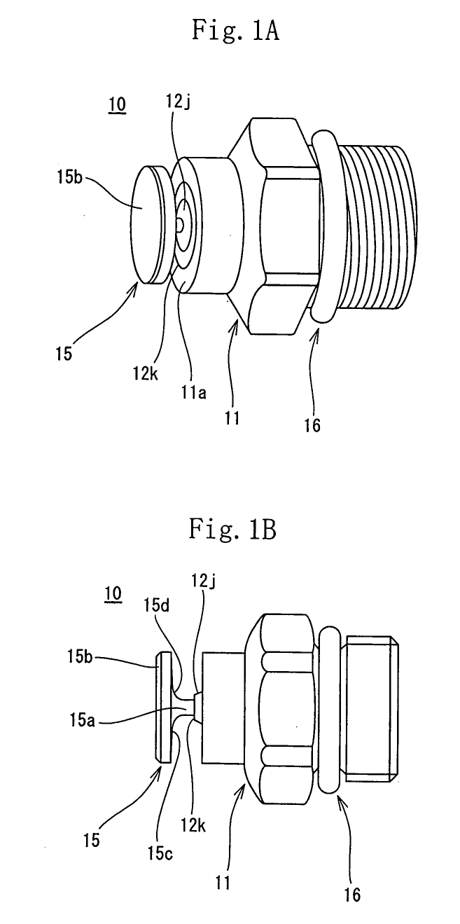

FIGS. 1 through 6 show the first embodiment of the present invention. A nozzle 10 includes a nozzle body 11, a nozzle tip 12, a packing 13, an adapter 14, a deflector 15, and an O-ring 16.

The nozzle body 11 is approximately cylindrical in its outer configuration, has a large aperture 11b on its front-end wall surface 11a, and has a nut portion 11c formed on its central peripheral portion. A ring groove lid is concavely formed rearward from the nut portion 11c. A screw portion 11e on which a fluid supply pipe (not shown) is installed is formed on the rear periphery of the nozzle body 11. A cylindrical spatial portion 11f communicating with the aperture 11b is formed inside the nozzle body 11.

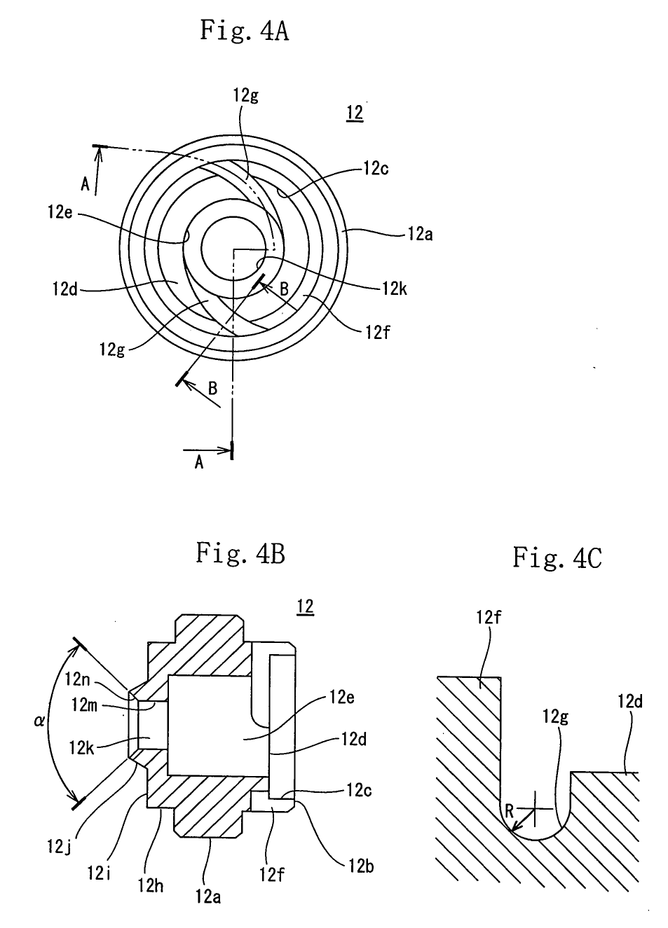

As shown in FIGS. 4(A) and (B), the nozzle tip 12 is a short columnar member and has a flange portion 12a formed at approximately the central portion of its periphery. On an end portion 12b at the rear side of the nozzle tip 12, a outer fitting portion 12c to be fitted on the adapter 14 is formed except a peripheral wall of the end portion 12b. A rear-end surface 12d is formed at the inner side of the outer fitting portion 12c. A central portion of the rear-end surface 12d is deeply concavely formed to form a cavity portion 12e serving as a swirl chamber. A curved swirl groove 12g communicating with a peripheral wall portion 12f and a cavity portion 12e is concavely formed as a swirl flow path at two opposed positions on the rear-end surface 12d. As shown FIG. 4 (C), the bottom surface of the swirl groove 12g is semicircular. In the swirl groove 12g of this embodiment, its groove width is set to 0.6 mm, its groove depth is set to 0.5 mm, and the radius R of its bottom surface is set to 0.3 mm. That is, the swirl groove 12g secures dimensions so that a fluid is capable of passing through the swirl groove 12g without the swirl groove 12g being clogged, even though an alien substance are mixed with the fluid.

The outer diameter of a peripheral portion 12h disposed forward from the flange portion 12a of the nozzle tip 12 is set to a dimension at which the peripheral portion 12h can be fitted in the aperture 11b of the front-end wall surface 11a of the nozzle body 11. A trapezoidal conic projected portion 12j is formed at a central portion of a front end surface 12i of the nozzle tip 12. A jetting nozzle 12k communicating with the cavity portion 12e formed inside the nozzle tip 12 is formed at a central portion of the projected portion 12j. A portion of the jetting nozzle 12k continuous with the cavity portion 12e is set as a same-diameter portion 12m having the same inner diameter. A portion of the jetting nozzle 12k disposed in the projected portion 12j is set as a diameter-enlarged portion 12n whose diameter increases gradually toward its front end. In the jetting nozzle 12k of this embodiment, the same-diameter portion 12m is set to φ2 mm, and the angle α of the diameter-enlarged portion 12n is set to 60 degrees.

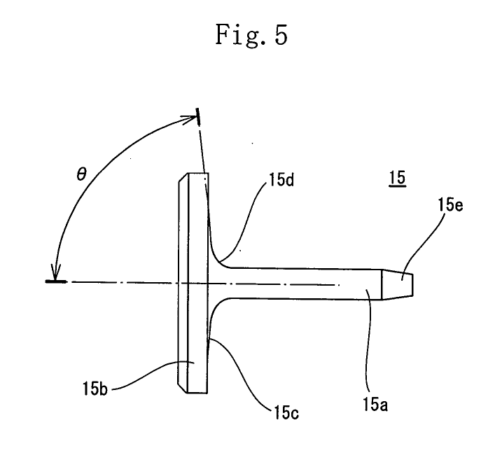

The adapter 14 to be fitted on the nozzle tip 12 at its rear portion which is a fluid inflow side is columnar. The outer diameter of a peripheral portion 14a of the adapter 14 is set smaller than the inner diameter of the spatial portion 11f of the nozzle body 11. The periphery of the adapter 14 at its front side is stepped to form an inner fitting portion 14b which fits on the nozzle tip 12. A trapezoidal conic protruded portion 14d is formed at a central portion of a front-end surface 14c. A fixed opening portion 14e for a support bar 15a of the deflector 15 is concavely formed at the center of the protruded portion 14d. As shown in FIG. 5, the deflector 15 has a disk-shaped impact plate portion 15b provided at one end of the support bar 15a so that the deflector 14 is umbrella-shaped. In this embodiment, the diameter of the support bar 15a is set to φ1.5 mm, and the outer diameter of the impact plate portion 15b is set to φ11 mm. A surface of the impact plate portion 15b at the side of the support bar 15a is set as an impact surface 15c against which the fluid impacts. An angle θ between the impact surface 15c and the support bar 15a is formed in the range of an acute angle to a right angle. In this embodiment, the angle θ is set to 85 degrees. A continuous portion 15d continuous with the impact plate portion 15b and an end of the support bar 15a is tapered and formed as a smooth curved surface from the periphery of the support bar 15a to the impact surface 15c of the impact plate portion 15b.

The curvature of the continuous portion 15d is set in conformity to the angle α of the diameter-enlarged portion 12n of the jetting nozzle 12k in the nozzle tip 12. More specifically, the direction of the tangential line at the curved surface of the continuous portion 15d is set to be almost the same as that of the extended direction of the diameter-enlarged portion 12n. The other end 15e, of the support bar 15a, opposite to the one end thereof where the impact plate portion 15b is provided is tapered off to allow the other end 15e to be easily inserted into the fixed opening portion 14e of the adapter 14.

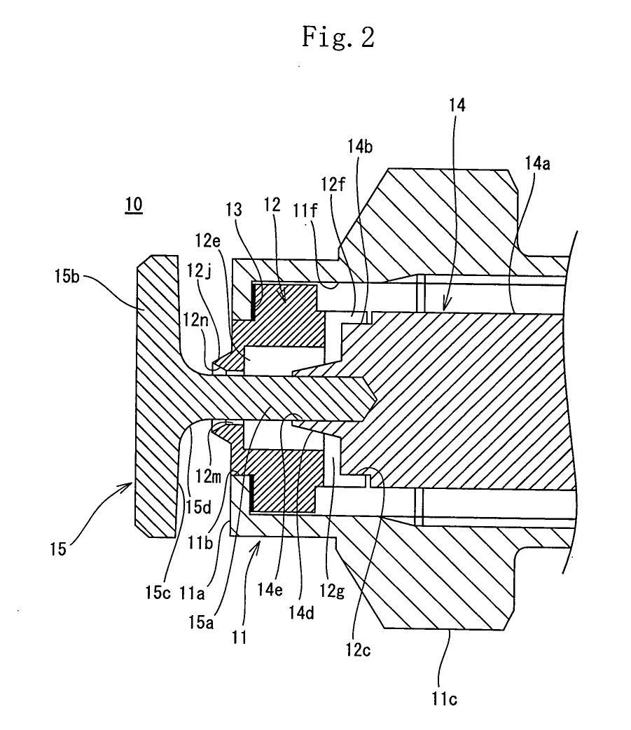

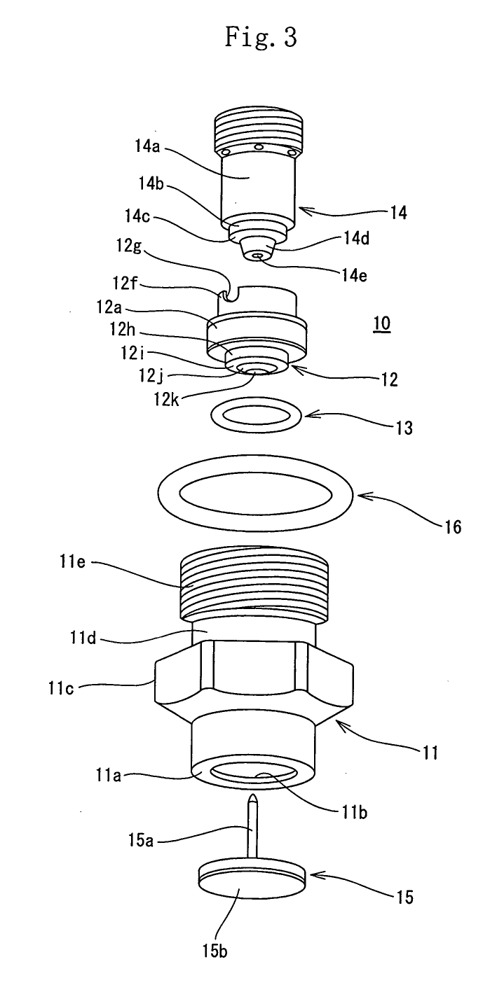

In assembling the nozzle 10, as shown in FIGS. 2 and 3, initially the nozzle tip 12 is accommodated at the front side of the spatial portion 11f formed inside the nozzle body 11 with the ring-shaped packing 13 fitted on a front surface of the flange portion 12a to fit the peripheral portion 12h of the nozzle tip 12 at its front side in the aperture 11b of the nozzle body 11. Thereafter the adapter 14 is accommodated in the spatial portion 11f of the nozzle body 11, and the inner fitting portion 14b of the adapter 14 at its front side is fitted on the outer fitting portion 12c disposed at the rear end of the nozzle tip 12 to contact the front-end surface 14c of the adapter 14 and the rear-end surface 12d of the nozzle tip 12 each other.

In the above-described state, the support bar 15a of the deflector 15 is inserted into the jetting nozzle 12k of the nozzle tip 12 and penetrated through the cavity portion 12e. Then the end 15e of the deflector 15 at its base side is inserted into the fixed opening portion 14e of the adapter 14 by press fit to thereby fix the deflector 15. Because the nozzle tip 12 and the adapter 14 are placed in position by the fitting between the outer fitting portion 12c and the inner fitting portion 14b, the nozzle tip 12 and the deflector 15 are also placed accurately in position. The support bar 15a is positioned at the center of the jetting nozzle 12k with a ring-shaped space formed between the support bar 15a and the periphery of the jetting nozzle 12k. In the jetting nozzle 12k, the ring-shaped space serves as a flow path having a sufficient dimension in its width. Finally the O-ring 16 is fitted on the ring groove lid formed on the periphery of the nozzle body 11. Thereby the assembling of the nozzle 10 is completed. The nozzle 10 is assembled from a large number of component parts, as described above, a flow path having a complicated construction can be easily formed.

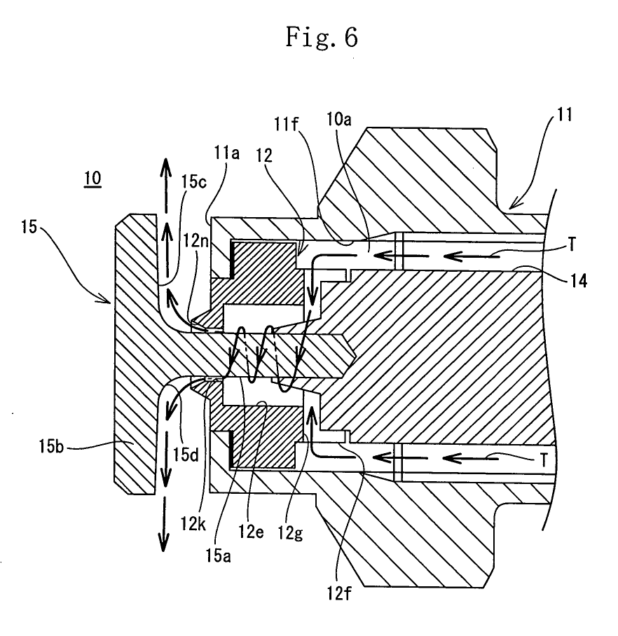

Jetting of a fluid by the nozzle 10 assembled as described above is described below with reference to FIG. 6.

The nozzle 10 is fastened to the fluid supply pipe (not shown) with the screw portion 11e of the nozzle body 11. A fluid T is fed into the nozzle 10 through the fluid supply pipe. In the nozzle 10, a flow path 10a for the fluid T is formed in the gap between the inner surface of the peripheral wall of the spatial portion 11f of the nozzle body 11 and the periphery of the adapter 14 as well as the nozzle tip 12. The fluid T fed into the nozzle 10 flows to the front side of the nozzle 10 through the flow path 10a.

The fluid T which has reached the peripheral wall portion 12f of the nozzle tip 12 flows into the swirl groove 12g. As a result of passing of the fluid T through the swirl groove 12g, the fluid T has a swirl state. The fluid T in the swirl state passes through the swirl groove 12g, enters the cavity portion 12e which is the swirl chamber, and flows to the jetting nozzle 12k with the jetting nozzle 12k keeping the swirl state. Because the support bar 15a of the deflector 15 is present in the center of the cavity portion 12e, the fluid T keeping the swirl state progresses with the fluid T swirling spirally around the periphery of the support bar 15a serving as the nucleus of the swirl. Thus the fluid T obtains a strong swirl force and is fine-grained.

The fluid T which has reached the jetting nozzle 12k is discharged outward from the gap between the support bar 15a and the periphery of the jetting nozzle 12k. In this jetting, because the diameter-enlarged portion 12n is formed at the front side of the jetting nozzle 12k, the fluid T is jetted in a direction a little outward from the direction along the periphery of the support bar 15a. The fluid T which has been jetted outward is deflected greatly in its direction along the curved surface of the continuous portion 15d continuous with the support bar 15a of the deflector 15 and the impact plate portion 15b. The deflected fluid T progresses in a substantially vertical direction along the impact surface 15c of the impact plate portion 15b and is jetted outward forcibly in a fine-grained state from the gap between the impact plate portion 15b and the front-end wall surface 11a of the nozzle body 11.

Because the fluid T jetted outward in this manner is guided to the outside along the impact surface 15c smoothly, the fluid T is jetted in a uniform film state without generating turbulence in the jet pattern and jet direction of the fluid T fine-grained by the swirl, thus maintaining a stable jet pattern under the guide of the diameter-enlarged portion 12n of the projected jetting nozzle 12k and the curved surface of the continuous portion 15d of the deflector 15. Further because in this state, the fluid T impacts against the deflector 15 gently, the amount of the fluid T which splashes toward the jetting nozzle 12k is small. In addition, because the jetting nozzle 12k itself projects from the front end surface 12i of the nozzle tip 12, it never occurs that the fluid T attaches to the periphery of the jetting nozzle and prevents jetting of the fluid.

Further a sufficient dimension is secured for portions, through which the fluid T passes, such as the flow path 10a, the swirl groove 12g, and the jetting nozzle 12k. Thus even if the fluid T contains foreign matters therein, the fluid T is jetted continuously without these fluid passage portions clogging. In addition, because the fluid passage portions have a large dimension respectively, it is possible to realize reliable jetting of even a small amount of the fluid. Moreover, even if the fluid has a high viscosity, it is possible to flow the fluid smoothly by reducing a pressure loss and the influence of a boundary layer and spray the fluid at a wide angle and uniformly by guiding the swirl flow by the deflector.

The nozzle 10 is capable of jetting fluids having a low viscosity and a high viscosity. Regarding the kind of the fluid, the nozzle 10 is capable of jetting a gas and a liquid. Further the nozzle 10 jets a fine-grained fluid at a wide angle. Thus as the application of the nozzle 10, the nozzle 10 can be utilized to form a protection coating film on the inner peripheral surface of a conduit which will be described later.

In the nozzle 10 provided with the deflector, by altering the configuration of the deflector 15, it is possible to form various jetting angles and jetting patterns.

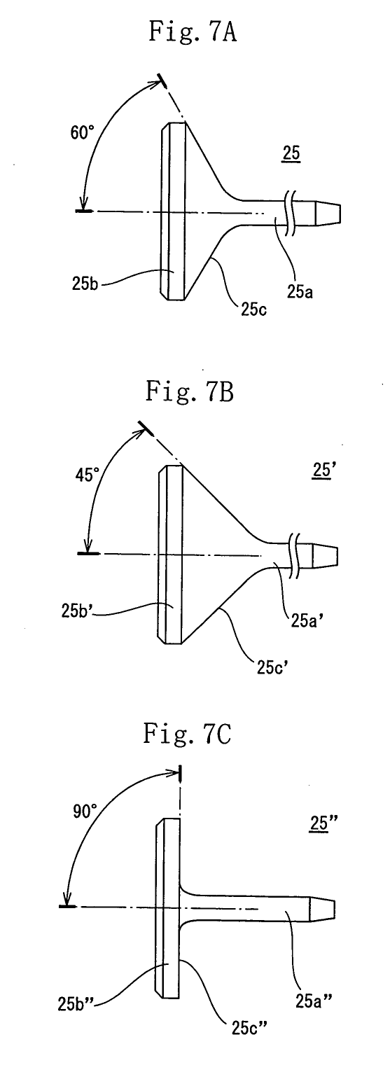

For example, as can be seen from deflectors 25, 25′ shown in FIGS. 7(A), (B), by making the angle of impact surfaces 25c, 25c′ of disk-shaped impact plate portions 25b, 25b′ smaller than 85 degrees which is the angle θ of the deflector 15 of the first embodiment, the angle of the impact surfaces 25c, 25c′ may be set to 60 degrees or 45 degrees to support bars 25a, 25a′. As can be seen from a deflector 25″ shown in FIG. 7(C), the angle of an impact surface 25c″ may be set to 90 degrees. The angle of the impact surface of the deflector can be set to not less than 45 degrees to the support bar.

In replacing the deflector, after the deflector is removed from the adapter 14, the deflector is fixed to the fixed opening portion 14e of the adapter 14 by press fit. Thereby the deflector can be easily mounted on the nozzle 10. When the deflectors 25, 25′ are used, the jetting angle of the nozzle is smaller than that of the nozzle having the deflector 15 mounted thereon. The deflectors 25, 25′ can be used preferably in jetting the fluid in an oblique forward direction. When the deflector 25″ is mounted on the nozzle 10, the jetting angle of the nozzle 10 is wider than that of the nozzle 10 having the deflector 15 mounted thereon. Thus a fluid is jetted approximately orthogonally to the axial direction of the nozzle 10. In altering the angle of the impact surface of the deflector, as described above, the angle of the diameter-enlarged portion 12n of the jetting nozzle 12k may be altered in conformity to the angle of the impact surface.

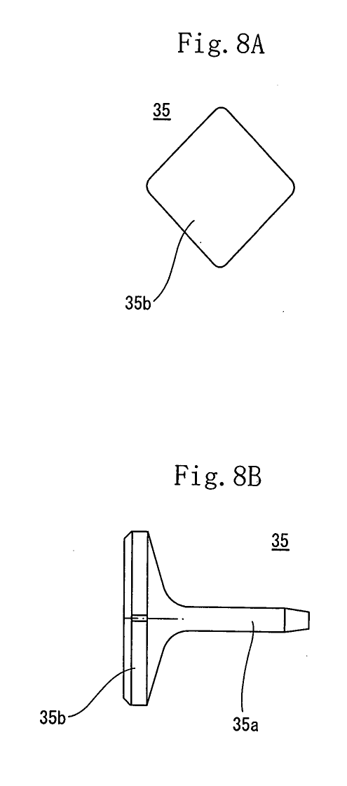

In the configuration of the deflector, as can be seen from a deflector 35 of FIGS. 8(A) and (B), the peripheral configuration of an impact plate portion 35b may be rectangularly formed. When the deflector is formed in this way, the jetting direction of the fluid is not uniform in all directions on the periphery of the nozzle but the jetting force at corners is low. Thus a spray pattern of spreading the fluid radially in four directions is formed. In addition to the rectangular shape, the peripheral configuration of the impact plate portion 35b may be polygonal such as triangular, pentagonal, hexagonal, heptagonal, and octagonal.

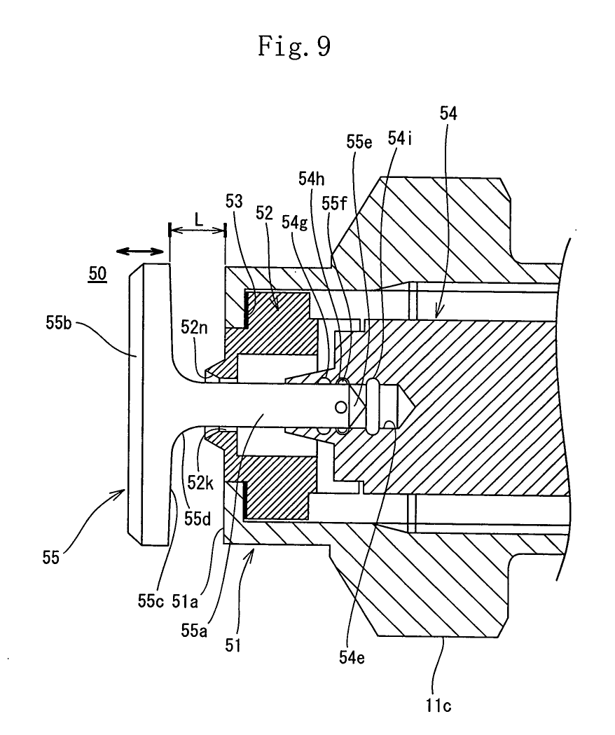

FIG. 9 shows a nozzle 50 of the second embodiment of the present invention. The distance L between an impact plate portion 55b of a deflector 55 and a front-end wall surface 51a of a nozzle body 51 can be adjusted so that a jetting mode can be adjusted. In the deflector 55, a ball plunger 55f urged by a spring is projected in the vicinity of an end portion 55e of a support bar 55a. In an adapter 54, a fixed opening portion 54e penetrating through the support bar 55a is formed deeper than the fixed opening portion 14e of the first embodiment, and first, second and third groove portions 54g, 54h, and 54i are concavely formed at certain intervals on an inner peripheral surface of the fixed opening portion 54e.

The dimension of each of the first through third groove portions 54g, 54h, and 54i is set to a dimension at which the ball plunger 55f of the support bar 55a can be fitted therein and locked thereto. The position of the second groove portion 54h is so set that with the support bar 55a inserted into the fixed opening portion 54e and with the ball plunger 55f fitted in the second groove portion 54h, the distance L between an impact surface 55c of the impact plate portion 55b and the front-end wall surface 51a is equal to the distance between the impact surface 55c and the front-end wall surface 11a of the nozzle 10 of the first embodiment. The first and third groove portions 54g, 54i are disposed by spacing them from the second groove portion 54h at an increase interval of the distance L or a decrease interval thereof.

The portions of the deflector 55 and the adapter 54 other than the above-described portions, the nozzle body 51, a nozzle tip 52, a packing 53, and other portions have the same construction and configuration as those of the corresponding portion of the nozzle 10 of the first embodiment.

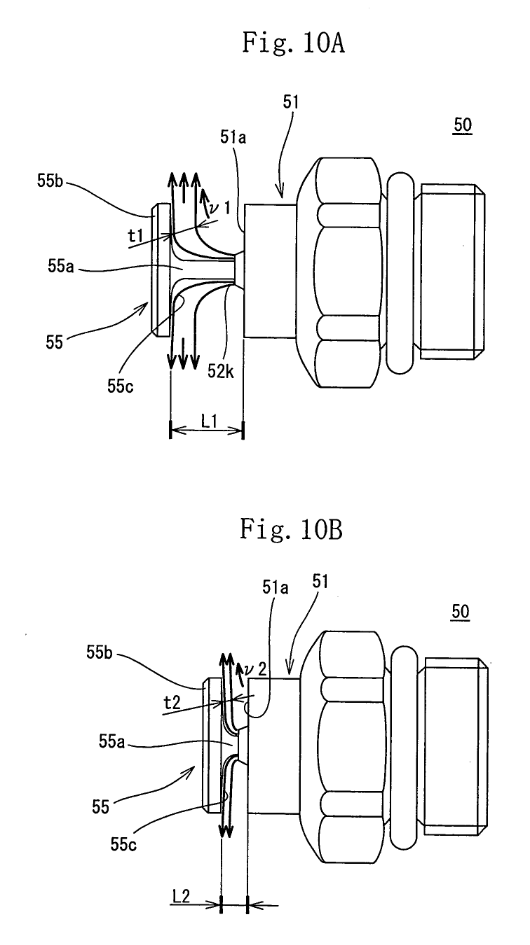

The jetting mode of the nozzle 50 is similar to that of the nozzle 10 of the first embodiment in the state, shown in FIG. 9, in which the ball plunger 55f is fitted in and locked to the second groove portion 54h. When the jetting mode is altered to make the jetting speed low, the deflector 55 is moved from the state shown in FIG. 9 toward a side in which the distance L becomes long, and the ball plunger 55f is fitted in and locked to the first groove portion 54g so that as shown in FIG. 10(A), the interval between the impact plate portion 55b and the front-end wall surface 51a has a distance L1.

When a fluid is jetted from the jetting nozzle 52k in a swirl state by setting above-described interval to the distance L1, the fluid is jetted in a direction in which the fluid widens outward along the diameter-enlarged portion 52n of the jetting nozzle 52k. Because the distance L1 is longer than the distance L, the fluid widens outward to a higher extent than the fluid jetted from the nozzle 10 of the first embodiment and impacts against the impact surface 55c of the impact plate portion 55b with the fluid having a large thickness t1 in a liquid film. Consequently a speed v1 of the fluid which is jetted outward from the periphery of the impact plate portion 55b is lower than that of the fluid jetted from the nozzle 10 of the first embodiment, and the particle diameter of the jetted fluid is larger than that of the jetted fluid jetted from the nozzle 10 of the first embodiment.

When the jetting mode is altered to make the jetting speed high, the deflector 55 is moved from the state shown in FIG. 9 toward a side in which the distance L becomes short, and the ball plunger 55f is fitted in and locked to the third groove portion 54i so that as shown in FIG. 10 (B), the interval between the impact plate portion 55b and the front-end wall surface 51a has a distance L2.

When the fluid is jetted from the jetting nozzle 52k in a swirl state by setting the above-described interval to the distance L2, the distance L2 is shorter than the distance L in the first embodiment. Thus the fluid impacts against the impact surface 55c with the fluid jetted from the jetting nozzle 52k not widening, namely, with a thickness t2 of the film of the fluid being smaller than that of the film of the fluid jetted from the nozzle 10 of the first embodiment. In the impact when the fluid film is thin, a jetting speed lost by the fluid in the impact is low. Consequently a speed v2 of the fluid which is jetted outward from the periphery of the impact plate portion 55b is higher than that of the fluid jetted from the nozzle 10 of the first embodiment, and thus the particle diameter of the jetted fluid is smaller than that of the fluid jetted from the nozzle 10 of the first embodiment.

As described above, by increasing or decreasing the distance L, it is possible to increase and decrease the jetting speed and the particle diameter of the fluid to be jetted. Thus the nozzle 50 can be used widely by merely adjusting the position of the deflector 55. In addition to fitting the ball plunger in the groove portion and locking the ball plunger thereto, the adjustment of the position of the deflector 55 may be accomplished by preparing a large number of deflectors having different lengths to obtain the desired distance L by selectively using an appropriate deflector. In addition, a deflector having a support bar whose length can be increased and decreased may be used. Deflectors of modifications of the first embodiment is applicable to the nozzle 50.

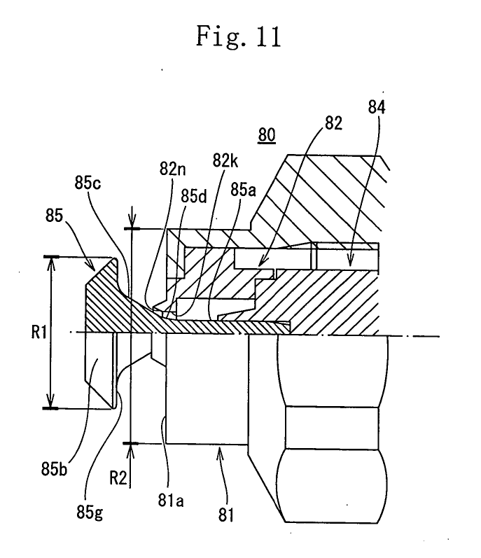

FIG. 11 shows a nozzle 80 of the third embodiment. An outer diameter R1 of an impact plate portion 85b of a deflector 85 is set smaller than an outer diameter R2 of a nozzle body 81 at its front-end wall surface 81a. The diameter of a continuous portion 85d continuous with the support bar 85a and the impact plate portion 85b and that of the impact surface 85c are enlarged from a position thereof opposed to a diameter-enlarged portion 82n of a jetting nozzle 82k. The angle of the continuous portion 85d and the impact surface 85c to the support bar 85a is set to 30 degrees. A peripheral surface 85g continuous with the impact surface 85c of the impact plate portion 85b is formed as a plane vertical to the support bar 85a.

The portions of the deflector 85 other than the above-described portions has the same construction as that of the deflector of the nozzle 10 of the first embodiment. The nozzle body 81, a nozzle tip 82, a packing, and an adapter 84 have also the same construction and configuration as those of the corresponding portion of the nozzle 10 of the first embodiment.

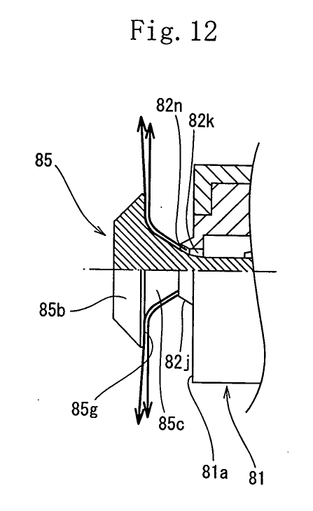

As shown in FIG. 12, in the jetting of the fluid from the nozzle 80, the fluid is jetted from the jetting nozzle 82k along the impact surface 85c of the deflector 85 and the diameter-enlarged portion 82n with the fluid widening outward to a higher extent than the fluid jetted from the nozzle 10 of the first embodiment, changes the flow direction under the guide of the peripheral surface 85g of the impact plate portion 85b, and is jetted outward from the periphery of the impact plate portion 85b. In the range from the jetting nozzle 82k to the impact plate portion 85b, by the impact surface 85c inclining from the root of the jetting nozzle 82k and extending in a diameter-enlarged direction, the fluid is forcibly directed outward in its flow. Thus a portion in which the flow stagnates is not generated on the periphery of the impact surface 85c, and very little fluid attaches to the impact surface 85c, even if jetting is continued.

Once the fluid is jetted outward from the impact plate portion 85b, the fluid is not affected by the impact plate portion 85b. The impact plate portion 85b of the nozzle 80 of the third embodiment has a smaller diameter than the nozzle body 81. Therefore compared with the nozzle 10 of the first embodiment, the fluid is not affected by the impact plate portion 85b in an early time. Therefore the fluid is smoothly jetted outward through the gap between the impact plate portion 85b and a front-end wall 81a of the nozzle body 81, and a portion in which the flow of the fluid separates from the front-end wall 81a of the nozzle body 81 and does not flow forward is not generated, and little fluid attaches to the periphery of the impact plate portion 85b and the periphery of the tip of the nozzle body 81.

Even if the fluid is jetted continuously, a portion to which the fluid attaches is not generated. Thus stable jetting can be ensured for a long time. Because the nozzle 80 guides the flow direction of the fluid mainly by the inclined impact surface 85c of the deflector 85, a projected portion 82j including the diameter-enlarged portion 82n therein may be eliminated from the jetting nozzle 82k. Modifications of the nozzle of the first embodiment is applicable to the nozzle 80. Further the nozzle 80 may be so constructed that the distance between the impact plate portion of the deflector and the front-end wall surface of can be adjusted to have various jetting modes.

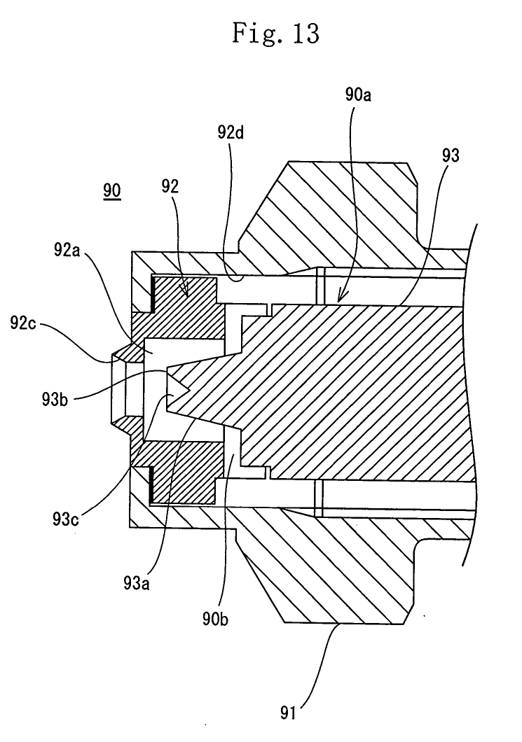

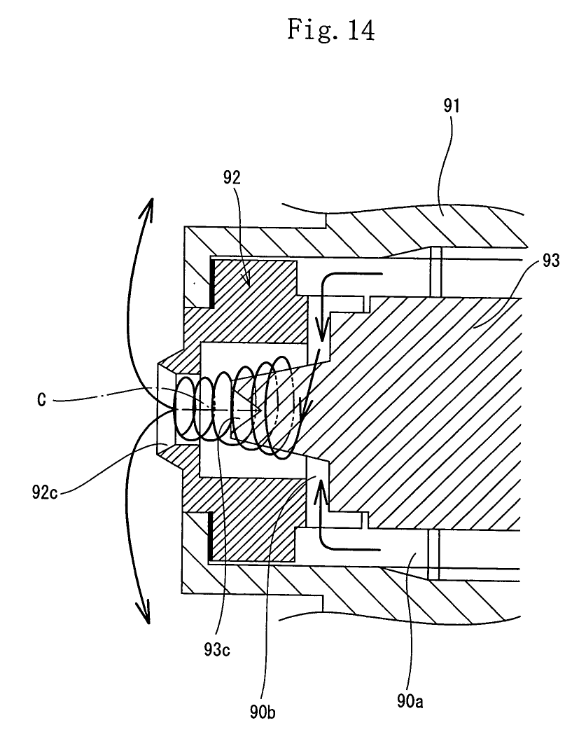

FIGS. 13 and 14 show a nozzle 90, of the fourth embodiment of the present invention, not provided with a deflector.

The nozzle 90 has a nozzle body 91, a nozzle tip 92, and an adapter 93 each having a configuration similar to that of the first embodiment. The nozzle 90 is different from the first embodiment in that the deflector is not provided, the projection amount of a trapezoidal conic protruded portion 93a projecting from the tip of the adapter 93 is different from the protruded portion of the first embodiment, and the configuration of a concave portion 93c formed on a front-end surface 93b of the protruded portion 93a is different from the concave portion of the first embodiment.

The trapezoidal conic protruded portion 93a projected into a cavity portion 92a, serving as a swirl chamber, formed inside the nozzle tip 92 has a larger projection amount than the protruded portion of the first embodiment to make the protruded portion 93a proximate to the jetting nozzle 92c and make the area of the front-end surface 93b of the protruded portion 93a equal to that of the jetting nozzle 92c, and make the axis of the protruded portion 93a coincident with the center of the jetting nozzle 92c.

The concave portion 93c formed on the front-end surface of the protruded portion is formed conically.

In the nozzle 90, similarly to the nozzle of the first embodiment, a ring-shaped flow path 90a is formed between the inner peripheral surface of the nozzle body 91 and the peripheral surface of the adapter 93. The flow path 90a communicates with the swirl chamber surrounded with the cavity portion 92a and the front-end wall of the adapter 93 through a swirl flow path 90b formed between a pair of curved swirl grooves 92d formed at opposed positions of the inner surface of the peripheral wall of the nozzle tip 92 and the front-end wall of the adapter 93. The trapezoidal conic protruded portion 93a is positioned at the center of an inflow side of the fluid spirally flowing into the swirl chamber from the swirl flow path 90b. The fluid spirally flowing into the swirl chamber is further swirled spirally along the peripheral surface of the trapezoidal conic protruded portion 93a and jetted from the jetting nozzle 92c formed at the tip of the swirl chamber at a wide angle to the periphery of the jetting nozzle 92c in the radial direction with the fluid being swirled.

Because other constructions are similar to those of the first embodiment, description thereof is omitted herein.

In the nozzle 90 not provided with the deflector, the fluid which has been flowed into the swirl chamber from the swirl flow path with the fluid being swirled is forcibly swirled along the peripheral surface of the trapezoidal conic protruded portion 93a. Further the protruded portion 93a is projected to a position proximate to the jetting nozzle 92c, and the outer diameter of the protruded portion is set almost equal to that of the jetting nozzle 92c. Therefore as shown in FIG. 14, the fluid can be jetted outward from the jetting nozzle 92c with the fluid being swirled spirally. Because the swirl flow is released to the air, it becomes a large swirl flow by a centrifugal force and is jetted radially at an angle wider than 90 degrees to the axis of the nozzle. Because an air core generated along the axis of the swirl flow can be accommodated in the conic concave portion 93c disposed on the front-end surface of the protruded portion, the air core can be held stably in the center of the jetting nozzle 92c. Thus by making the center of the swirl flow jetted from the jetting nozzle 92c always coincident with the center of the jetting nozzle 92c, the jetted fluid can be distributed uniformly in the radial direction.

Further, by swirling the fluid along the periphery of the trapezoidal conic protruded portion 93a, it is possible to fine-grain the fluid. Even the nozzle not provided with the deflector is allowed to have performance almost equal to that of the deflector-provided nozzle of the first embodiment.

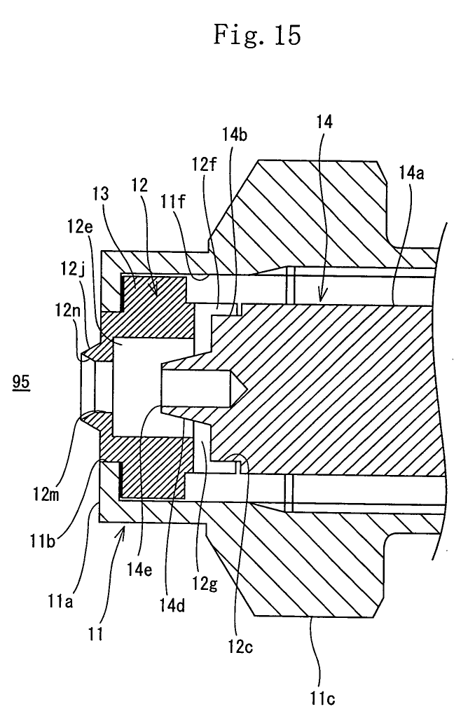

FIG. 15 shows a nozzle 95 of a modification of the fourth embodiment. The nozzle of the modification is the same as the nozzle 10 of the first embodiment except that the nozzle of the modification is not provided with the deflector 15. Thus the same component parts have the same reference numerals and description thereof is omitted herein.

The present inventors have repeated experiments on the nozzle of the first embodiment by removing the deflector therefrom. In the experiments, by using a viscous fluid at a low pressure as the fluid to be jetted, the nozzle of the fourth embodiment provides wide-angle jetting similar to that obtained by the deflector-provided nozzle.

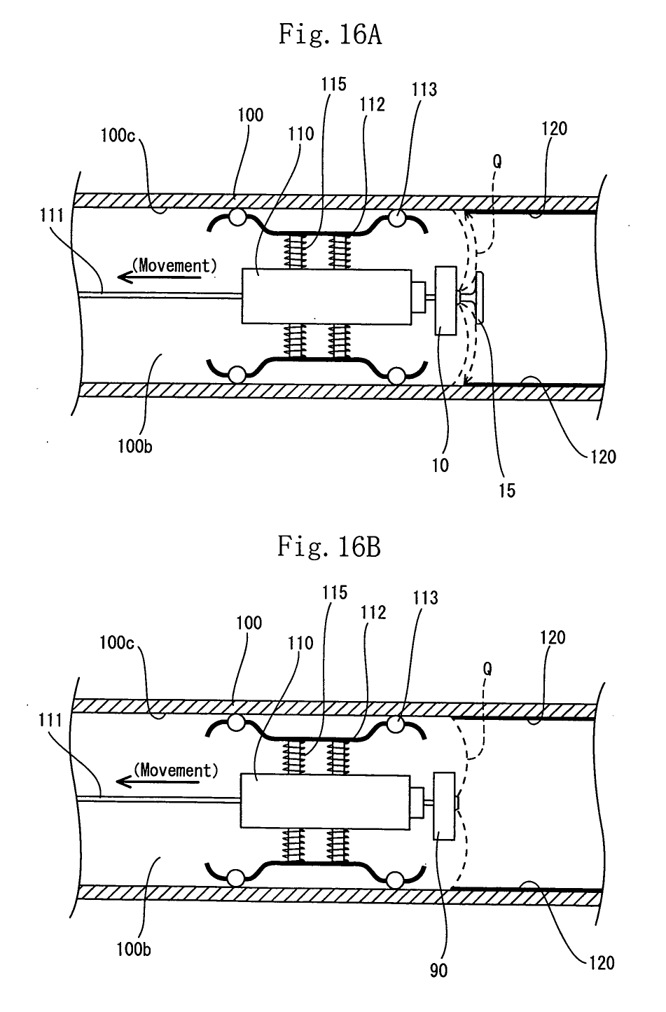

FIGS. 16(A) and (B) show the fifth embodiment. FIG. 16(A) shows a method of forming a protection coating film 120 on an inner peripheral surface 100a of a gas-flowing conduit 100 by using the nozzle 10 of the first embodiment. FIG. 16(B) shows the case in which the nozzle 90 of the fourth embodiment is used.

A rope 111 serving as a towing means is stretched to a jetting apparatus 110 on which the nozzle 10 or the nozzle 90 is mounted to allow a hollow part 100b of the gas pipe to move along an axis shown with the arrow. Guide rollers 113 are mounted on a guide plate 112 projected from the jetting apparatus 110 by urging the guide plate 112 with a coil spring 115. The guide rollers 113 slidably contacts the inner peripheral surface 100c of the gas conduit 100.

Paint Q consisting of two-part hardening resin is jetted from the nozzle 10 or 90 mounted on the jetting apparatus 110.

Let is be supposed that the side of the jetting apparatus 110 where the nozzle 10 (90) is located is set as the front end thereof. The jetting apparatus 110 is moved rearward as shown with the arrow. The paint Q is jetted from the nozzle 10 (90) disposed at the front end of the jetting apparatus 110 at a wide angle not less than 90 degrees (nearly 180 degrees in FIG. 16(A)) to the axis of the nozzle. Therefore the paint Q is uniformly applied to the entire inner peripheral surface of the conduit 100.

As a first application, the paint is applied to the inner surface of the conduit by jetting the paint thereto by the deflector-provided nozzle 10. As a second application, the paint is applied to the inner surface of the conduit by jetting the paint thereto by the deflector-unprovided nozzle 90. Finally as a third application, the paint is jetted thereto from the deflector-provided nozzle 10. Even if the inner peripheral surface of the conduit has irregularities, it is possible to form the coating layer 120 having a uniform thickness on the entire inner peripheral surface of the conduit including the surface of the irregularities.

### INDUSTRIAL APPLICABILITY

As apparent from the foregoing description, according to the present invention, both the deflector-provided nozzle and the deflector-unprovided nozzle are capable of jetting the fluid at a wide angle to the entire periphery thereof. Therefore the nozzle can be used suitably when a coating film is formed on the inner peripheral surface of a conduit. In the deflector-provided nozzle, a curved surface is formed continuously with the support bar of the deflector and the impact plate portion thereof. Therefore the fluid impacts the deflector gently and is guided outward smoothly to form a spray pattern having a stable configuration. Even when the jetting angle is not less than 150 degrees, a stable spray pattern can be maintained. Even if the fluid to be jetted has a high viscosity, the nozzle is also capable of maintaining a stable spray pattern. The nozzle is capable of jetting the fine-grained fluid uniformly at a wide angle.

In addition, because the deflector can be easily removably mounted on the nozzle, various jetting angles and spray patterns can be formed by preparing a large number of deflectors having various modes. Jetting can be accomplished in dependence on purpose. When the distance between the impact plate portion of the deflector and the front-end wall is adjustable, various jetting modes can be realized. When the outer diameter of the impact plate portion is set smaller than that of the nozzle body, it is possible to prevent an atomized fluid from attaching to the periphery of the front-end wall and the like and hence secure a stable successive jetting for a long lime.

Furthermore in both the deflector-provided nozzle and the deflector-unprovided nozzle, a sufficient dimension is secured for the flow path inside the nozzle. Thus a foreign matter contained in the fluid is capable of passing through the flow path without clogging. Thereby labor required to maintain the nozzle can be reduced.

1-16. (cancelled)

17. A nozzle in which a swirl chamber communicating with a jetting nozzle disposed at a center of a jetting-side front-end wall is provided; a support bar of a deflector is penetrated through said jetting nozzle with a gap formed between said support bar and a periphery of said jetting nozzle and is projected inward; an impact plate portion of said deflector is provided at an end portion of said support bar outward projected; and said impact plate portion is disposed in confrontation with said jetting-side front-end wall,
a fluid jetted in a swirl state from said swirl chamber through said jetting nozzle is impacted against said impact plate portion of said deflector to jet said fluid peripherally outwardly from a gap between said impact plate portion and said jetting-side front-end wall.

18. The nozzle according to claim 17, wherein said jetting nozzle is formed on a nozzle tip accommodated inside a nozzle body at a jetting side thereof; a cavity portion is formed inside said nozzle tip at a fluid inflow side thereof; and an adapter is fitted on an end portion of said nozzle tip at said fluid inflow side thereof in such a way as to close said cavity portion to thereby function said cavity portion as said swirl chamber;
a swirl flow path is formed on a peripheral portion of said nozzle tip to flow a fluid flowing along a flow path formed between an inner surface of a peripheral wall of said nozzle body and a periphery of said nozzle tip as well as said adapter into said swirl chamber as a swirl flow through said swirl flow path; and
an end portion, of said support bar of said deflector, disposed opposite to said impact plate portion is removably mounted on a front-end surface of said adapter.

19. The nozzle according to claim 18, wherein a front-end surface of said nozzle tip at which said jetting nozzle is formed is fitted on an aperture formed at a front-end portion of said nozzle body; and a peripheral portion of said jetting nozzle of said nozzle tip is projected from said front-end surface of said nozzle tip; and an inner diameter of said jetting nozzle is enlarged gradually toward a front end thereof.

20. The nozzle according to claim 19, wherein a continuous portion continuous with a support bar of said deflector and an impact plate portion thereof is tapered and formed as a curved surface in conformity to an angle of said jetting nozzle.

21. The nozzle according to claim 17, wherein an impact surface, of said impact plate portion of said deflector, disposed at a side of said jetting nozzle is formed at an angle of not less than 25 nor more than 90 degrees to said support bar.

22. The nozzle according to claim 17, wherein a distance between said impact plate portion of said deflector and said jetting-side front-end wall can be increasingly or decreasingly changed.

23. The nozzle according to claim 17, wherein an outer diameter of said impact plate portion of said deflector is set smaller than an outer diameter of said jetting-side front-end wall.

24. The nozzle according to claim 17, wherein a periphery of said impact plate portion of said deflector is formed circularly or polygonally.

25. A nozzle in which a ring-shaped flow path is formed along an inner surface of a peripheral wall of a nozzle body; a swirl chamber communicating with a jetting nozzle positioned at a center of an end of said nozzle body at a jetting side thereof is formed; said swirl chamber and said flow path are communicated with each other through a pair of curved swirl flow paths formed at opposed positions; a trapezoidal conic protruded portion is formed at a center of said swirl chamber at an inflow side thereof; and a fluid flowing swirlingly into said swirl chamber is further swirled along a peripheral surface of said trapezoidal conic protruded portion and jetted from said jetting nozzle formed at a front end of said swirl chamber at a wide angle with said fluid being swirled.

26. The nozzle according to claim 25, wherein an axis of said trapezoidal conic protruded portion is coincident with an axis of said jetting nozzle; a front-end surface of said trapezoidal conic protruded portion is disposed at a position proximate and opposed to said jetting nozzle; and a size of said jetting nozzle is set equally to a size of said front-end surface of said protruded portion.

27. The nozzle according to claim 26, wherein an opening is concavely formed at a center, of said front-end surface of said protruded portion, positioned on an axis of an air core of a swirl flow swirled in said swirl chamber and jetted from said jetting nozzle; and said air core of said swirl flow is stably held at said center of said jetting nozzle.

28. The nozzle according to claim 27, wherein said opening concavely formed at said center of said front-end surface of said protruded portion is conically shaped to decrease a diameter of said opening toward an inner end thereof.

29. The nozzle according to claim 25, wherein a nozzle tip is accommodated inside said nozzle body at a jetting side thereof; an adapter is accommodated inside said nozzle body at an inflow side thereof with respect to said nozzle tip; said ring-shaped flow path is formed between a peripheral surface of said adapter and an inner peripheral surface of said nozzle body; and said trapezoidal conic protruded portion is projected from a front-end surface of said adapter at a jetting side thereof;
the jetting nozzle is formed at a front end of said nozzle tip; a cavity portion, having a large area, continuous with said jetting nozzle is formed inside said nozzle tip; said swirl chamber is formed by closing a fluid inflow side of said cavity portion with a front-end surface of said adapter; and a swirl groove is formed at a position, of an inner surface of a peripheral wall of said nozzle tip, opposed to said front-end surface of said adapter.

30. The nozzle according to claim 17, wherein a fluid to be supplied to said nozzle is paint having a high viscosity; and said nozzle is used to line a conduit such as a gas pipe by spraying said paint to an inner peripheral surface of said conduit.

31. The nozzle according to claim 25, wherein a fluid to be supplied to said nozzle is paint having a high viscosity; and said nozzle is used to line a conduit such as a gas pipe by spraying said paint to an inner peripheral surface of said conduit.

32. A method of jetting a fluid to an inner peripheral surface of a conduit by means of a nozzle according to claim 25 by moving said nozzle inside said conduit at a required speed and jetting a fluid to an inner peripheral surface of said conduit from said nozzle at an angle not less than 90 degrees with respect to an axis of said nozzle.

33. A method of jetting a fluid to an inner peripheral surface of a conduit by means of a nozzle according to claim 29 by moving said nozzle inside said conduit at a required speed and jetting a fluid to an inner peripheral surface of said conduit from said nozzle at an angle not less than 90 degrees with respect to an axis of said nozzle.

34. A method of jetting a fluid to an inner peripheral surface of a conduit by means of a nozzle, wherein a fluid to be jetted from said nozzle consists of paint having a high viscosity; and said paint is jetted to said inner peripheral surface of said conduit to form a coating film thereon.
